(19) United States
(12) Patent Application Publication
(10) Pub. No.: US 2026/0180652 A1
(43) Pub. Date: Jun. 25, 2026

(54) QUANTIZATION PARAMETER SIGNALING FOR RANK AUGMENTATION AND ASSOCIATED DEVICES, SYSTEMS, AND METHODS

(71) Applicant: QUALCOMM Incorporated, San Diego, CA (US)

(72) Inventors: Amit BAR-OR TILLINGER, Tel-Aviv (IL); Assaf TOUBOUL, Netanya (IL); Gideon Shlomo KUTZ, Ramat Hasharon (IL); Michael LEVITSKY, Rehovot (IL); Ronen SHAKED, Kfar Saba (IL)

(21) Appl. No.: 18/999,947

(22) Filed: Dec. 23, 2024

(51) Int. Cl. H04B 7/06; H04W 72/1273; H04W 72/23

(52) U.S. Cl. CPC H04B 7/0626; H04W 72/1273; H04W 72/23

(57) ABSTRACT

Systems, methods, and devices for quantization parameter signaling for rank augmentation in wireless communications are described. According to an aspect of the present disclosure, a method performed by a user equipment (UE) comprises: receiving, from a network unit, a first control communication; transmitting, to a wireless communication device, a second control communication indicating one or more quantization parameters, wherein the one or more quantization parameters are based on the first control communication; receiving, from the network unit, a downlink data communication; and receiving, from the wireless communication device, a quantized downlink data communication, wherein the quantized downlink data communication is based on the one or more quantization parameters and the downlink data communication.

### TECHNICAL FIELD

This application relates to wireless communication systems, and more particularly to wireless communication methods and systems that use quantization parameters and configurations to facilitate quantization and decoding of wireless communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHZ to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes schemes, methods, and mechanisms for signaling and using signal processing parameters for rank augmentation in wireless communications between a user equipment (UE) and a network unit (e.g., a BS, a RU, a DU, etc.). For instance, the UE may be associated with a companion wireless communication device capable of receiving downlink signals sent from the network unit to the UE. The UE may transmit signaling to the companion wireless communication device indicating one or more signal processing parameters for the companion wireless communication device to use for processing downlink communications. The companion wireless communication device may apply the one or more signal processing parameters and transmit, to the UE, an at least partially processed downlink communication. The UE receives the at least partially processed downlink communication from the companion device, and further processes the at least partially processed downlink communication to obtain a decoded downlink communication.

In some aspects, the companion device may be relatively uncorrelated from the UE. For instance, the companion device may include another UE, or a smart wearable device having its own antenna and signal processing circuitry. By using both the companion device's RF antenna and signal processing circuitry, in conjunction with the UE's antenna(e) and signal processing circuitry, the rank of the communication channels between the UE and the network unit can be effectively increased. For instance, the companion device may transmit a quantized version of a downlink signal from the network unit (e.g., downlink data) to the UE over a different wireless link, after the companion device filters, amplifies, converts, and quantizes the downlink signal, but prior to (or without) demodulating and decoding it. The UE may then use both its own signal processing chain, and the quantized downlink signal sent from the companion device, to demodulate and decode the communication.

According to an aspect of the present disclosure, a method performed by a user equipment (UE) comprises: receiving, from a network unit, a first control communication; transmitting, to a wireless communication device, a second control communication indicating one or more quantization parameters, wherein the one or more quantization parameters are based on the first control communication; receiving, from the network unit, a downlink data communication; and receiving, from the wireless communication device, a quantized downlink data communication, wherein the quantized downlink data communication is based on the one or more quantization parameters and the downlink data communication.

According to another aspect of the present disclosure, a method performed by a wireless communication device comprises: receiving, from a user equipment (UE), a control communication indicating one or more quantization parameters; receiving, from a network unit, a downlink data communication; and transmitting, to the UE, a quantized downlink data communication, wherein the quantized downlink data communication is based on the one or more quantization parameters and the downlink data communication.

According to another aspect of the present disclosure, a UE comprises: one or more memory devices; and one or more processors in communication with the one or more memory devices, wherein the UE is configured to: receive, from a network unit, a first control communication; transmit, to a wireless communication device, a second control communication indicating one or more quantization parameters, wherein the one or more quantization parameters are based on the first control communication; receive, from the network unit, a downlink data communication; and receive, from the wireless communication device, a quantized downlink data communication, wherein the quantized downlink data communication is based on the one or more quantization parameters and the downlink data communication.

According to another aspect of the present disclosure, a UE comprises: one or more memory devices; and one or more processors in communication with the one or more memory devices, wherein the wireless communication device is configured to: receive, from a user equipment (UE), a control communication indicating one or more quantization parameters; receive, from a network unit, a downlink data communication; and transmit, to the UE, a quantized downlink data communication, wherein the quantized downlink data communication is based on the one or more quantization parameters and the downlink data communication.

Other aspects and features of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 illustrates a wireless communication network according to one or more aspects of the present disclosure.

FIG. 2 illustrates a diagram of an example disaggregated base station architecture according to one or more aspects of the present disclosure.

FIG. 3 illustrates a wireless communication scheme between a network unit, a user equipment (UE), and one or more companion wireless communication devices, according to some aspects of the present disclosure.

FIG. 4 is a schematic diagram illustrating the signal processing chains of a UE and a companion wireless communication device according to some aspects of the present disclosure.

FIG. 5 is a signaling diagram of a method for signaling one or more quantization parameters according to one or more aspects of the present disclosure.

FIG. 6 is a signaling diagram of a method for signaling one or more quantization parameters according to one or more aspects of the present disclosure.

FIG. 7 illustrates a block diagram of a UE according to one or more aspects of the present disclosure.

FIG. 8 illustrates a block diagram of a network unit according to one or more aspects of the present disclosure.

FIG. 9 illustrates a block diagram of a companion device according to one or more aspects of the present disclosure.

FIG. 10 illustrates a flow diagram of a wireless communication method according to some aspects of the present disclosure.

FIG. 11 illustrates a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communication networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For instance, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For instance, in various outdoor and macro coverage deployments of less than 3GHz FDD/TDD implementations, subcarrier spacing may occur with 15 kHz, for instance over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For instance, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/DL that may be flexibly configured on a per-cell basis to dynamically switch between UL and DL to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For instance, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For instance, a method may be implemented as part of a system, device, apparatus, as instructions stored on a computer readable medium for execution on a processor or computer, or a combination of two or more of the above. Furthermore, an aspect may comprise at least one element of a claim.

The present disclosure describes schemes, mechanisms, and methods to enhance or improve wireless communications between a UE and a network unit. For instance, a UE (e.g., a smartphone, a cellular smart watch, cellular tablet, etc.) may be associated with a companion device also capable of receive wireless communications. In some aspects, the wireless companion device may include a wireless smart wearable device (e.g., smart watch, smart glasses, smart ring, another UE, etc.) The UE and the companion device may be configured to communicate with one another over one or more wireless links (e.g., sidelink, ultra wideband (UWB), Bluetooth, WiFi, etc.). In some instances, the companion device may be relatively limited compared to the UE. For instance, the companion device may have power limitations associated with a smaller battery. The companion device may have wireless communication limitations associated with a smaller antenna, low-power RF circuitry, or other limitations. However, the wireless communication device may still be capable of monitoring for and receiving downlink communications from a network unit (e.g., BS, RU, DU) and the UE. The companion device's antenna and RF signal processing circuitry can effectively provide uncorrelated augmentation for communications between the network unit and the UE. For example, both the UE and the companion device may receive a downlink signal from the network unit. The companion device may filter, amplify, convert, and quantize the downlink signal, and transmit the quantized downlink signal to the UE. The UE may also filter, amplify, convert, and quantize the downlink signal it receives from its own antennas. The UE may use both its own quantized downlink signal, as well as the quantized downlink signal from the companion device, to demodulate and decode the downlink signal. By using uncorrelated versions of the same signal in this way, the communication rank of the UE can be effectively increased, or augmented.

In some aspects, the companion device may not monitor for all of the same reference signals and control information that the UE monitors for from the network. The companion device may therefore not be aware of communication parameters (e.g., allocation rank, modulation and coding scheme (MCS)) that facilitate proper reception, processing, and decoding of wireless communications. According to aspects of the present disclosure, the UE may signal, to the companion device, one or more quantization parameters for the companion device to use to quantize downlink signals. The companion device may quantize the downlink signal based on those quantization parameters to ensure signal quality (e.g., SQNR, SINR) is sufficient to maintain performance, while keeping the number of bits per sample as low as possible so that the overall payload transmitted from the companion device can be reduced.

The schemes, mechanisms, and methods described in this disclosure assist in effectively increasing the rank of communications between the UE and network by taking advantage of wireless communication capabilities in companion devices. The embodiments of the present disclosure provide for this rank augmentation even though the companion device may have power or communication limitations compared to the UE, and are not capable of monitoring the full bandwidth monitored by the UE.

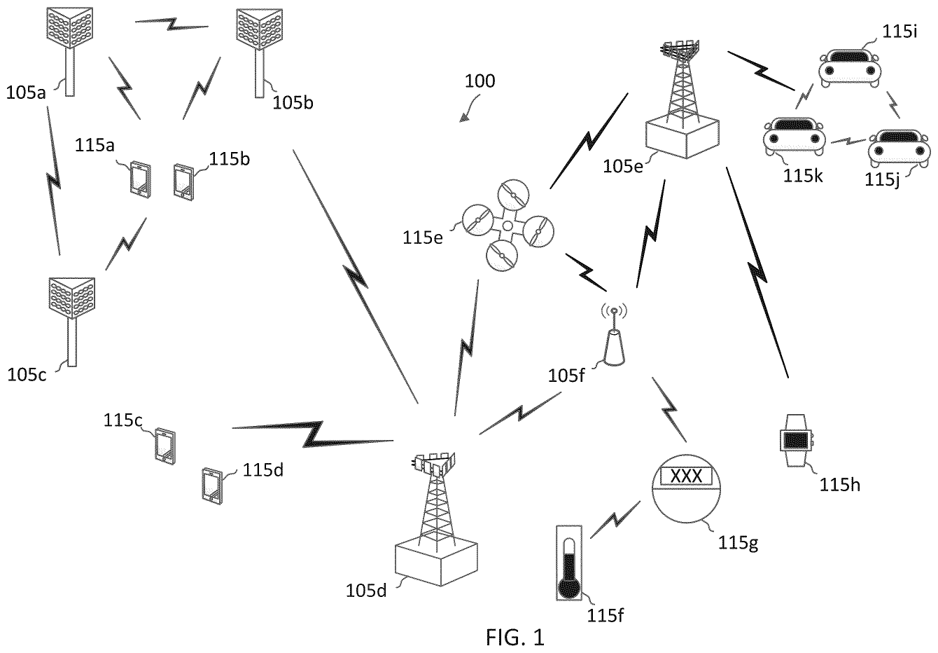

FIG. 1 illustrates a wireless communication network 100 according to one or more aspects of the present disclosure. The network 100 may be a 5G network. The network 100 includes a number of BSs 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a 300next generation eNB (gNB), an access point, and the like. Each BS 105 may provide communication coverage for a particular geographic area. In 3GPP, the term “cell” can refer to this particular geographic coverage area of a BS 105 or a BS subsystem serving the coverage area, depending on the context in which the term is used.

A BS 105 may provide communication coverage for a macro cell or a small cell, such as a pico cell or a femto cell, or other types of cells or a combination thereof. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

In some aspects, the term “base station” (e.g., the base station 105) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. A “network entity” may also be referred to as a “network unit.” In some aspects, the term “base station” or “network entity” may refer to one device configured to perform one or more functions, such as those described herein in connection with the base stations 105. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are instances of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are instances of various machines configured for communication that access the network 100. The UEs 115i-115k are instances of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the DL, UL, or both, desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an instance of a gNB or an access node controller (ANC)) may interface with the core network through backhaul links (e.g., NG-C, NG-U, etc.) and may perform radio configuration and scheduling for communication with the UEs 115. In various cases, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, vehicle-to-infrastructure (V2I) communications between a UE 115i, 115j, or 115k and a BS 105, or a combination thereof.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing, the duration of TTIs, or both, may be scalable.

In some aspects, the BSs 105 can assign or schedule transmission resources (e.g., in the form of time-frequency resource blocks (RB)) for DL and UL transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for instance, about 10. Each slot may be further divided into mini-slots. In a FDD mode, simultaneous UL and DL transmissions may occur in different frequency bands. For instance, each subframe includes a UL subframe in a UL frequency band and a DL subframe in a DL frequency band. In a TDD mode, UL and DL transmissions occur at different time periods using the same frequency band. For instance, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For instance, each DL or UL subframe may have pre-defined regions for transmissions of reference signals, control information, and data. Reference signals are predetermined signals that facilitate the communications between the BSs 105 and the UEs 115. For instance, a reference signal can have a particular pilot pattern or structure, where pilot tones may span across an operational BW or frequency band, each positioned at a pre-defined time and a pre-defined frequency. For instance, a BS 105 may transmit cell specific reference signals (CRSs), channel state information-reference signals (CSI-RSs), or both, to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data, operational data, or a combination thereof. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for DL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, the MIB, or a combination thereof, in the form of synchronization signal block (SSBs) and may broadcast the RMSI, the OSI, or a combination thereof, over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI, OSI, or both. After decoding the MIB, the UE 115 may receive RMSI, OSI, or both. The RMSI and OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI, the OSI, or a combination thereof, the UE 115 can perform a random access procedure to establish a connection with the BS 105. In some instances, the random access procedure may be a four-step random access procedure. For instance, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), a backoff indicator, or a combination thereof. Upon receiving the random access response, the UE 115 may transmit a connection request to the BS 105 and the BS 105 may respond with a connection response. The connection response may indicate a contention resolution. In some instances, the random access preamble, the RAR, the connection request, and the connection response can be referred to as message 1(MSG 1 ), message 2(MSG 2 ), message 3(MSG 3 ), and message 4(MSG 4 ), respectively. In some instances, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For instance, the BS 105 may schedule the UE 115 for UL and DL communications. The BS 105 may transmit UL and DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH or PUCCH according to a UL scheduling grant. The connection may be referred to as an RRC connection. When the UE 115 is actively exchanging data with the BS 105, the UE 115 is in an RRC connected state.

In some aspects, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), a packet data network gateway (PGW), or a combination thereof, to complete the network attachment procedure. For instance, the BS 105 may coordinate with the network entities in the 5GC to identify the UE, authenticate the UE, or authorize the UE for sending or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for instance, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). After receiving the DL data packet, the UE 115 may transmit a feedback message for the DL data packet to the BS 105. In some instances, the UE 115 may transmit the feedback on an acknowledgment resource. The feedback may be an acknowledgement (ACK) indicating that reception of the DL data packet by the UE 115 is successful (e.g., received the DL data without error) or may be a negative-acknowledgement (NACK) indicating that reception of the DL data packet by the UE 115 is unsuccessful (e.g., including an error or failing an error correction). In some aspects, if the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For instance, the BWP pair may include one BWP for UL communications and one BWP for DL communications.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

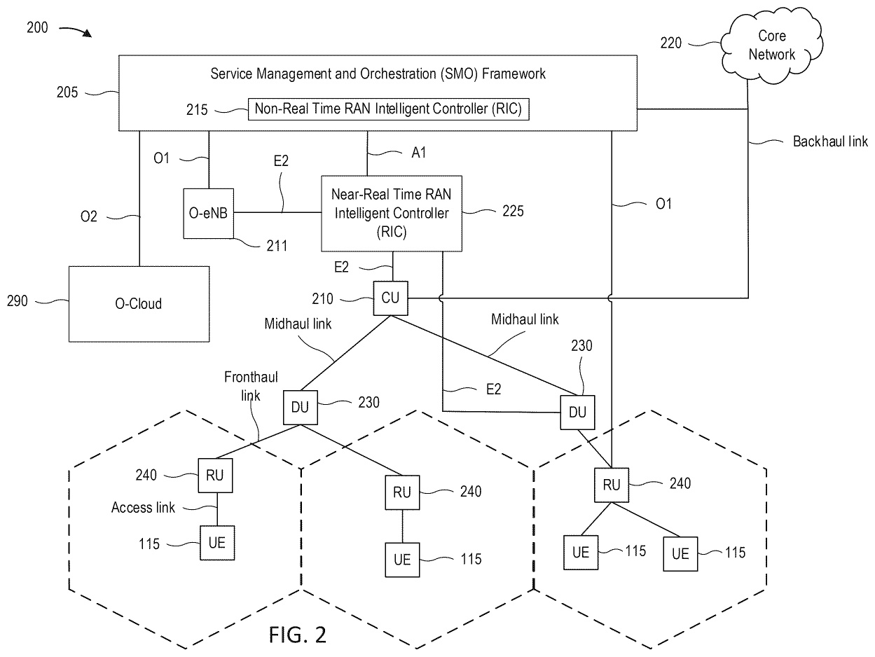

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUs 210, the DUs 230, the RUs 240, as well as the Near-RT RICs 225, the Non-RT RICs 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O 1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

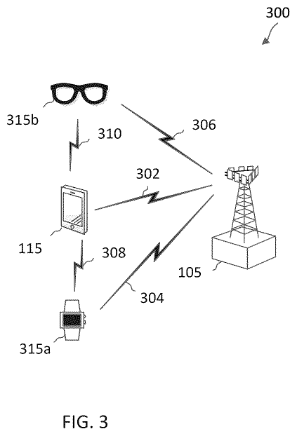

FIG. 3 illustrates wireless communication scheme 300 involving a network unit 105, a UE 115, a first companion device 315a, and a second companion device 315b. In some aspects, the scheme 300 may be used to increase or augment a communication rank of the UE 115 for communicating with the network unit 105. For instance, by employing the antennae and receiving circuitry of the companion devices 315a and 315b, in addition to the antenna (or antennae) and receiving circuitry of the UE 115, the UE 115 may be able to effectively increase its communication performance (e.g., modulation and coding scheme, SINR). In some aspects, one or both of the companion devices 315a, 315b may have power limitations or other limitations in their ability to monitor and/or decode communications from the network unit 115. For instance, the companion device 315a, 315b may include wearable smart devices with relatively smaller batteries compared to the UE 115. The companion devices 315a, 315b may not be connected with the network unit 105 over the same frequency range (e.g., bandwidth part (BWP)) as the UE 115. Thus, in some instances, the companion devices 315a, 315b may not monitor the same control channels (e.g., PDCCH) as the UE 115, and therefore may not be aware of the UE's allocation rank and MCS, and may not be able to identify its own sampled signal SINR.

The scheme 300 involves a plurality of wireless links 302, 304, 306, 308, and 310. In some aspects, the links 302, 304, and 306, which all involve the network unit 105, may be Uu links using Uu communication protocols and signal architectures. In another aspect, the links 308, 310 may be UWB links. However, other types of links and protocols are contemplated, including WiFi, WiMAX, PC5 sidelink, and/or any other type of wireless link. As mentioned above, in some aspects, the links 304 and 306 may have different configurations and/or capabilities compared to the link 302. The companion devices 315a, 315b may receive downlink communications (e.g., downlink data, PDSCH, etc.) intended for the UE 115. Because the antennae on the companion devices 315a, 315b are separated by several wavelengths, those antennae may provide uncorrelated augmentation to receive the downlink signals. As explained in more detail below, the companion devices 315a, 315b may quantize those downlink signals and transmit quantized representations of the downlink signals to the UE 115 to facilitate its demodulation and decoding of the downlink signals. The quantized representations of the downlink signals may comprise quantized samples. The quantized signals may be sent over UWB to the UE. In effect, the additional quantized signal(s) provided by the companion device 315a, the companion device 315b, or both, may effectively be treated as additional antennae for the UE 115. In this way, the signal quality of the downlink signals may be effectively increased, resulting in a higher communication rank between the UE 115 and the network unit 105.

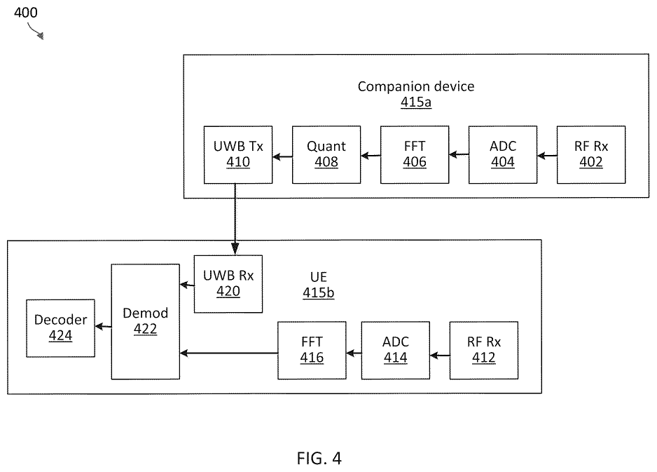

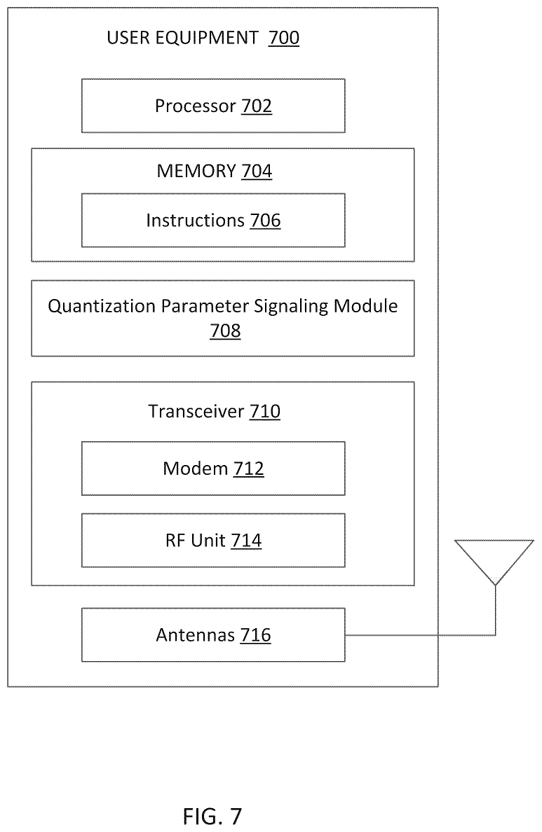

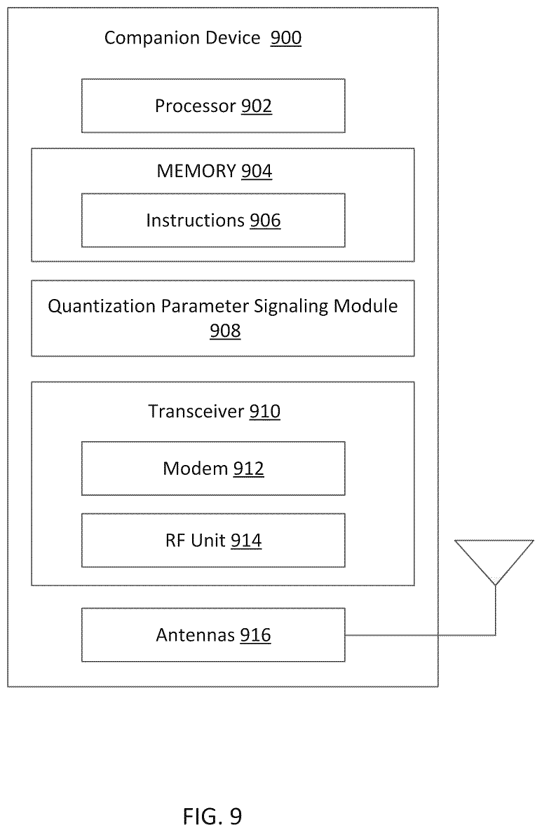

FIG. 4 is a schematic diagram of signal processing circuitry and modules for a companion device 415a and a UE 415b. The circuitry shown in FIG. 4 can be understood in conjunction with the diagrams in FIGS. 7 and 9 to describe the architecture of a UE and a companion device that facilitate the methods and mechanisms described herein. Although FIG. 4 illustrates the UE 415b and the companion device 415a as including somewhat different combinations of circuitry and modules, it will be understood that the UE 415b and the companion device 415a may have one or more identical components, or similar components, and that each device may include other features or components not explicitly shown in FIG. 4.

The companion device 415a comprises a radiofrequency (RF) receiver (Rx) 402, a analog-to-digital converter (ADC), a fast-fourier transformer (FFT) 406, a quantizer 408, and a UWB transmitter 410. In some aspects, one or more of these elements may be provided on a same hardware component. For instance, one or more of these elements may be implemented on a computer chip, or a modem. In some aspects, one or more of these components may be implemented on an application-specific integrated circuit (ASIC), a field-programmable gate array (FPGA), a system-on-a-chip (SOC), a general purpose processor, or any other suitable hardware device or combination thereof.

The RF receiver 402 is responsible for receiving the wireless signal transmitted over the air. Receiving the wireless signal may involve receiving high-frequency electromagnetic waves, performing signal amplification, filtering unwanted frequencies, and down-conversion to an intermediate frequency (IF) or baseband signal using a local oscillator and mixer. The RF receiver 402 may prepare a relatively weak, high-frequency signal captured by the antenna for further processing by the other components of the companion device 415a.

The ADC 404 may convert a continuous-time signal a discrete-time signal to provide a sampled signal. For example, the ADC 404 may function as a digital signal conditioner. It will be understood that the ADC 404 shown in FIG. 4 may be described as a sampler. In that regard, the output of the ADC 404 may not be fully digitized bits, but a sampled representation of the incoming analog signal from the RF receiver 402. The ADC 404 may obtain samples based on a sampling rate. The ADC 404 may perform quantization on the analog signal. Quantization may be performed with sufficient resolution (bit depth) to maintain data fidelity while managing system bandwidth and noise levels.

The FFT 406 performs the transformation of the received signal from the time domain to the frequency domain. The FFT 406 may decompose the wideband signal into its constituent frequency components, enabling the demodulation of each subcarrier. It will be understood that, in some aspects, the FFT 406 may not be involved in the signal processing chain shown in FIG. 4, and the time domain signal may be instead provided to the UE 415b via UWB.

The Quantizer 408 converts the signal data from the FFT into discrete digital values for further processing may perform additional quanitization on the input digital signal provided by the FFT 406, or the ADC 404. In that regard, the digital signal provided by the FFT may be based on a relatively high accuracy quantization performed at the DS 404. The Quantizer 408 may perform quantization on the digital signal to reduce the number of bits per sample. This reduction in bits per sample may facilitate a balance in the interests of required UWB bandwidth for communicating the signal and the signal accuracy or precision (e.g., bits per sample). As explained further below, the quantizer 408 may quantize the signals based on quantization parameters. One or more of the quantization parameters may be signaled from the UE 415b. For instance, the UE 415b may include UWB transmitting circuitry to transmit the one or more quantization parameters. The one or more quantization parameters may include one or more of a quantization type, a number of bits per sample component, or a decision threshold. The one or more quantization parameters may be explicitly signaled by the UE 415b (e.g., a value or index for each parameter), or implicitly signaled by the UE 415b (e.g., an index associated with a quantization configuration).

The UWB transmitter 410 may include one or more antennae and other RF signal processing circuitry to prepare the signal from the quantizer 408 for transmission over the air to the UE 415b, based on UWB frequencies and UWB protocols. In some aspects, the UWB transmitter 410 may use the same antenna (or antennae) as used by the RF receiver 402. In other aspects, the UWB transmitter may have one or more dedicated antennae to transmit UWB signals. In some aspects, the UWB transmitter 410 may transmit quantized representations of downlink signals received by the companion device 415a via the RF receiver 402.

The UE 415b comprises one or more components which may be similar or identical to one or more components of the companion device 415a, including an RF receiver 412, an ADC 414, and an FFT 416. Additionally, the UE 415b comprises a UWB receiver 420. The UWB receiver 420 is configured to receive UWB communications from the companion device 415a over a UWB link. For instance, the UWB receiver 420 receives quantized signals from the companion device 415a transmitted via the UWB transmitter 410. In some aspects, the UWB receiver 420 is configured to receive a quantized downlink signal from the UWB transmitter 410. For instance, the UWB receiver 420 may be configured to receive a quantized version of a PDSCH signal carrying downlink data from the UWB transmitter 410 of the companion device 415a. The PDSCH signal may have also been received by the RF receiver 412, and processed by the ADC 414, and the FFT 416. The demodulator 422 of the UE 415b may then demodulate the downlink signal using information using a first quantized signal from the FFT 416, and a second quantized signal received from the UWB receiver 420, which was quantized by the companion device 415a. The demodulated signal may then be decoded by decoder 424. In some aspects, the signal received from the companion device's UWB module 410 comprises a time domain signal. For instance, the companion device 415a may not have, or may skip, the FFT 406 and pass the time domain signal directly to the quantizer 408 for quantization (or re-quantization with lower bits per sample). In other aspects, the quantized signal transmitted by the UWB 410 is a frequency domain signal that has been processed by the FFT 406 into the frequency domain signal.

Using two quantized signals, or quantized representations of a signal, to demodulate and decode the signal may provide increased decoding performance, which may allow the UE 415b to have an increased or augmented rank for communications with the network.

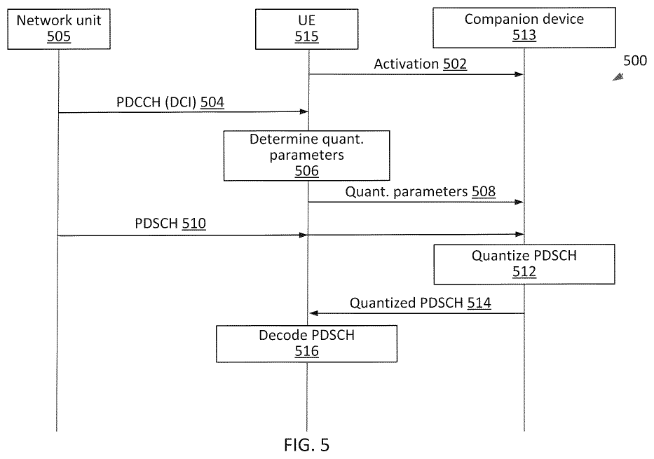

FIG. 5 is a signaling diagram of a wireless communication scheme 500 for quantization parameter signaling according to aspects of the present disclosure. The scheme 500 may include or incorporate aspects of the scheme 300, and may involve devices such as the UE 415b and the companion device 415a. For instance, the UE 515 in the scheme 500 may comprise the UE 415b in FIG. 4, and the companion device 513 may comprise the companion device 415a. The network unit 505 may comprise a base station (e.g., a base station 105), a CU, a DU, a RU, or a combination thereof.

At action 502, the UE 514 transmits, and the companion device 513 receives, an activation request. In some aspects, action 502 comprises an activation process involving the activation request and an activation response from the companion device 513. In some aspects, the activation of action 502 may trigger the companion device 513 to monitor certain signals from the network unit 505, from the UE 515, or both. In some aspects, action 502 involves UWB communications over a UWB link. However, other types of wireless links and protocols are contemplated, including WiFi, WiMAX, PC5, or any other suitable type of wireless link.

At action 504, the network unit 505 transmits, and the UE 515 receives, a PDCCH communication including DCI. The PDCCH may be transmitted via a Uu link between the UE 515 and the network unit 505. In some aspects, the DCI comprises information associated with one or more quantization parameters. In some aspects, the information may indicate information about the MCS, channel conditions, SNR, rank, or any other relevant information about the PDSCH. The information about the rank may indicate, or be associated with, a number of data streams or a multiple input-multiple output (MIMO) order of the PDSCH.

In some aspects, as the MCS, the rank, or both, increases, the UE may increase the accuracy of the companion device signal by adjusting the quantization parameters (for example by increasing the number of bits per sample). The reason is that higher MCS and higher rank may rely on relatively higher SNR for a successful decoding. Thus, the quantization noise may also be reduced by increasing the number of bits per sample to facilitate efficient decoding of the sample.

In some aspects, the information may comprise, or indicate, a quantization type (e.g., linear or non-linear), a number of bits per sample component, a decision threshold for non-linear quantization, representation levels for non-linear quantization, or any other suitable parameters. In some aspects, the information may comprise a Max-Lloyd value.

At action 506, the UE 515 determines, based on the DCI received at action 504, one or more quantization parameters to signal to the companion device 513. For instance, the UE 515 may evaluate the information in the DCI to determine the one or more quantization parameters. In some aspects, the UE 515 determines the one or more quantization parameters based on additional factors or information, such as the available UWB bandwidth for communication with the companion device, for example. In some aspects, the one or more quantization parameters may comprise a quantization type (e.g., linear or non-linear), a number of bits per sample component, a decision threshold for non-linear quantization, representation levels for non-linear quantization, or any other suitable parameters. In some aspects, the one or more quantization parameters may comprise a Max-Lloyd value.

At action 508, the UE 515 transmits, and the companion device 513 receives, a communication indicating the one or more quantization parameters determined at action 506. In some aspects, the communication of action 508 includes a UWB signal communicated over a UWB link. In another aspect, the communication may include a sidelink communication communicated over a PC5 link in a sidelink channel. In other aspects, the communication may be communicated using a WiFi link, a WiMAX link, or any other suitable type of wireless link.

In some aspects, the transmission of the communication at action 508 may include a periodic communication transmitted based on periodic resources configured at the UE 515 and the companion device 513. The communication may be associated with a configured periodicity. In other aspects, the communication of action 508 may be an aperiodic communication that is dynamically configured or scheduled by the UE 515. In another aspect, the one or more quantization parameters may be indicated explicitly in the communication. For instance, the communication may indicate specific values associated with each of the one or more quantization parameters. In another aspect, one or more of the one or more quantization parameters may be implicitly indicated in the communication. For instance, the communication may include one or more indices associated with each of the one or more quantization parameters. The companion device 513 may be configured (e.g., statically, semi-statically, or dynamically) to identify the appropriate quantization parameter(s) based on the one or more indices. In other aspects, a single index may be provided in the communication to indicate one of a plurality of pre-configured quantization configurations. Each quantization configuration may comprise a pre-defined set of quantization parameters.

At action 510, the network unit 505 transmits, and the UE 515 and companion device 513 receive, a downlink communication. In the illustrated embodiment, the downlink communication comprises a PDSCH communication. However, other types of Uu downlink communications are contemplated. As explained above, the respective antennae of each of the UE 515 and the companion device 513 may be separated from each other by several wavelengths, meaning that the signals received at each of the UE 515 and companion device 513 are relatively uncorrelated. For instance, the UE 515 may comprise a smartphone in a user's right hand, and the companion device 513 may comprise a smart watch worn on the user's left wrist. In some aspects, action 510 includes each device (UE 515 and companion device 513) using signal processing components to receive, filter, amplify, convert, and transform the received signal for processing at a quantizer. FIG. 4 and the associated text describes additional details of the signal processing chain.

At action 512, the companion device 512 quantizes the downlink signal based on the one or more quantization parameters signaled at action 508. In some aspects, the quantization includes a process of converting a continuous range of signal values (from an analog or digitized waveform) into a finite set of discrete levels. Quantization may be one step in transforming an analog signal into a digital format that can be processed into data bits usable by a computer processor. For instance, the received downlink signal may first be digitized using an analog-to-digital converter (ADC). The ADC samples the signal at regular intervals (determined by the sampling rate) and produces a digital representation of the amplitude at each sample. The quantizer assigns each sampled value to the nearest discrete level within a predetermined set. The quantized signal may then be input into a demodulator, and then to a decoder, to obtain a decoded signal. In this example, the quantization based on the one or more quantization parameters may be performed on the time domain signal. In another example, the quantization may be performed on the frequency domain signal after FFT. For instance, the companion device 512 may first quantize the downlink signal as part of the ADC process, and then quantize the frequency domain signal after the FFT process. In that regard, the initial quantization at the ADC may not be based on the quantization parameters signaled at action 508, and the second quantization performed after FFT may be based on the quantization parameters signaled at action 508.

At action 514, the companion device 513 transmits, and the UE 515 receives, a quantized downlink signal. The quantized downlink signal may comprise a quantized time domain signal (e.g., after ADC). In another aspect, the quantized downlink signal comprise a frequency domain signal that has been re-quantized after FFT. In some aspects, the quantized downlink signal may be referred to as a quantized representation of the downlink signal, or a quantized version of the downlink signal. In an exemplary aspect, the quantized downlink signal may be transmitted over a UWB link. However, other types of links are also contemplated, including sidelink (PC5), WiFi, or WiMAX.

At action 516, the UE 515 decodes the downlink signal (e.g., PDSCH) based on the quantized downlink signal it receives at action 514. For instance, with reference to FIG. 4, the UE 515 may include a UWB receiver module that receives the quantized downlink signal and provides the quantized downlink signal to a demodulator. The UE 515 may also feed its own quantized downlink signal into the demodulator, so that the demodulator can demodulate the downlink signal using both quantized versions of the downlink signal. The demodulator may perform the demodulation based on a MCS associated with the quantization parameters signaled to the companion device 513. The demodulated signal is then provided to a decoder, which decodes the demodulated signal to extract the information.

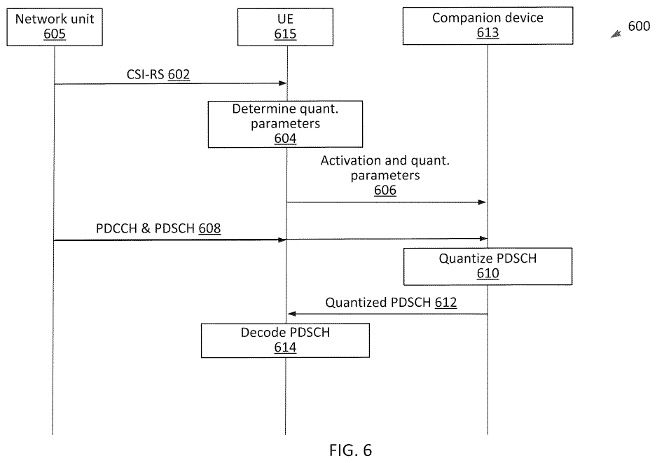

FIG. 6 is a signaling diagram of a wireless communication scheme 600 for quantization parameter signaling according to aspects of the present disclosure. The scheme 600 may include or incorporate aspects of the scheme 300, and may involve devices such as the UE 415b and the companion device 415a. For instance, the UE 615 in the scheme 600 may comprise the UE 415b in FIG. 4, and the companion device 613 may comprise the companion device 415a. The network unit 605 may comprise a base station (e.g., a base station 105), a CU, a DU, a RU, or a combination thereof.

As will be explained below, in FIG. 6, activation of the companion device 513 may be performed after the UE 615 receives a first downlink signal, which in this case is a CSI-RS. One or more aspects of the method 600 may be otherwise similar or identical to the method 500.

At action 602, the network unit 605 transmits, and the UE 615 receives, a CSI-RS. In some aspects, the CSI-RS may indicate information associated with, or otherwise relevant to, a quantization configuration.

At action 604, the UE 615 determines, based on the CSI-RS received at action 602, one or more quantization parameters to signal to the companion device 613. In some aspects, the one or more quantization parameters may comprise a quantization type (e.g., linear or non-linear), a number of bits per sample component, a decision threshold for non-linear quantization, representation levels for non-linear quantization, or any other suitable parameters. In some aspects, the one or more quantization parameters may comprise a Max-Lloyd value. In some aspects, the UE 615 may evaluate a required SQNR of the companion device based on the CSI-RS received at action 602.

At action 606, the UE 615 transmits, and the companion device 613 receives, a communication including an activation request and the one or more quantization parameters determined at action 604. In some aspects, the communication of action 608 includes a UWB signal communicated over a UWB link. In another aspect, the communication may include a sidelink communication communicated over a PC5 link in a sidelink channel. In other aspects, the communication may be communicated using a WiFi link, a WiMAX link, or any other suitable type of wireless link.

In some aspects, action 606 comprises an activation process involving the activation request and an activation response from the companion device 613. In some aspects, the activation of action 606 may trigger the companion device 613 to monitor certain signals from the network unit 605, from the UE 615, or both. In some aspects, action 602 involves UWB communications over a UWB link. However, other types of wireless links and protocols are contemplated, including WiFi, WiMAX, PC5, or any other suitable type of wireless link.

In some aspects, the transmission of the communication at action 606 may include a periodic communication transmitted based on periodic resources configured at the UE 615 and the companion device 613. The communication may be associated with a configured periodicity. In other aspects, the communication of action 608 may be an aperiodic communication that is dynamically configured or scheduled by the UE 615. In another aspect, the one or more quantization parameters may be indicated explicitly in the communication. For instance, the communication may indicate specific values associated with each of the one or more quantization parameters. In another aspect, one or more of the one or more quantization parameters may be implicitly indicated in the communication. For instance, the communication may include one or more indices associated with each of the one or more quantization parameters. The companion device 613 may be configured (e.g., statically, semi-statically, or dynamically) to identify the appropriate quantization parameter(s) based on the one or more indices. In other aspects, a single index may be provided in the communication to indicate one of a plurality of pre-configured quantization configurations. Each quantization configuration may comprise a pre-defined set of quantization parameters.

At action 608, the network unit 605 transmits, and the UE 615 and companion device 513 receive, a downlink communication. The downlink communication may include a PDCCH communication including DCI, and a PDSCH. In some aspects, the UE 615 may monitor for both the PDCCH and the PDSCH, and the companion device 613 may monitor for the PDSCH but not the PDCCH. The PDSCH may be transmitted via a Uu link.

As explained above, the respective antennae of each of the UE 615 and the companion device 613 may be separated from each other by several wavelengths, meaning that the signals received at each of the UE 615 and companion device 613 are relatively uncorrelated. For instance, the UE 615 may comprise a smartphone in a user's right hand, and the companion device 613 may comprise a smart watch worn on the user's left wrist. In some aspects, action 610 includes each device (UE 615 and companion device 613) using signal processing components to receive, filter, amplify, convert, and transform the received signal for processing at a quantizer. FIG. 4 and the associated text describes additional details of the signal processing chain.

At action 610, the companion device 613 quantizes the downlink signal based on the one or more quantization parameters signaled at action 608. In some aspects, the quantization includes a process of converting a continuous range of signal values (from an analog or digitized waveform) into a finite set of discrete levels.

At action 612, the companion device 613 transmits, and the UE 615 receives, a quantized downlink signal. In some aspects, the quantized downlink signal may be referred to as a quantized representation of the downlink signal, or a quantized version of the downlink signal. In an exemplary aspect, the quantized downlink signal may be transmitted over a UWB link. However, other types of links are also contemplated, including sidelink (PC5), WiFi, or WiMAX.

At action 614, the UE 615 decodes the downlink signal (e.g., PDSCH) based on the quantized downlink signal it receives at action 614. For instance, with reference to FIG. 4, the UE 615 may include a UWB receiver module that receives the quantized downlink signal and provides the quantized downlink signal to a demodulator. The UE 615 may also feed its own quantized downlink signal into the demodulator, so that the demodulator can demodulate the downlink signal using both quantized versions of the downlink signal. The demodulator may perform the demodulation based on a MCS associated with the quantization parameters signaled to the companion device 613. The demodulated signal is then provided to a decoder, which decodes the demodulated signal to extract the information.

FIG. 7 is a block diagram of a UE 700 according to one or more aspects of the present disclosure. The UE 700 may be, for instance, a UE 115 as discussed in FIGS. 1 and 2. The UE 600 may be the UE 415b of FIG. 4, the UE 515 of FIG. 5, or the UE 615 of FIG. 6. As shown, the UE 700 may include a processor 702, a memory 704, a Quantization Parameter Signaling Module 708, a transceiver 710 including a modem subsystem 712 and an RF unit 714, and one or more antennas 716. These elements may be coupled with one another. The term “coupled” may refer to directly or indirectly coupled or connected to one or more intervening elements. For instance, these elements may be in direct or indirect communication with each other, for instance via one or more buses.

The processor 702 may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, solid state memory device, hard disk drives, other forms of volatile and non-volatile memory, or a combination of different types of memory. In an aspect, the memory 704 includes a non-transitory computer-readable medium. The memory 704 may store, or have recorded thereon, instructions 706. The instructions 706 may include instructions that, when executed by the processor 702, cause the processor 702 to perform the operations described herein with reference to a UE 115 in connection with aspects of the present disclosure, for instance, aspects of FIGS. 3-6. Instructions 706 may also be referred to as program code. The program code may be for causing a wireless communication device to perform these operations, for instance by causing one or more processors (such as processor 702) to control or command the UE 700 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The Quantization Parameter Signaling Module 708 may be implemented via hardware, software, or combinations thereof. For instance, the Quantization Parameter Signaling Module 708 may be implemented as a processor, circuit, or as instructions 706 stored in the memory 704 and executed by the processor 702. In some aspects, the Quantization Parameter Signaling Module 708 can be integrated within the modem subsystem 712. For instance, the Quantization Parameter Signaling Module 708 can be implemented by a combination of software components (e.g., executed by a DSP or a general processor) and hardware components (e.g., logic gates and circuitry) within the modem subsystem 712. The Quantization Parameter Signaling Module 708 may communicate with one or more components of the UE 700 to implement various aspects of the present disclosure, for instance, aspects of FIGS. 3-6.

In some aspects, the Quantization Parameter Signaling Module 708 may be configured, along with other components of the UE 700, to determine one or more quantization parameters to communicate to a companion device. The companion device may comprise another UE, which may include one or more components similar or identical to the UE 700. The Quantization Parameter Signaling Module 708 may determine the one or more quantization parameters based on a downlink signal received from a network unit. The downlink signal may comprise a PDCCH carrying a DCI, a CSI-RS, or any other suitable signal or communication that indicates, or is associated with, one or more parameters for receiving, processing, demodulating, or decoding downlink communications. The one or more quantization parameters may include one or more of a quantization type, a sampling rate, or a decision threshold.

In some aspects, the Quantization Parameter Signaling Module 708 may be configured to transmit a communication indicating the one or more quantization parameters to the companion device. In another aspect, the Quantization Parameter Signaling Module 708 is configured to participate in, or assist, the reception of a quantized downlink signal from the companion device, where the quantized signal is generated based on the one or more quantization parameters signaled to the companion device.

As shown, the transceiver 710 may include the modem subsystem 712 and the RF unit 714. The transceiver 710 can be configured to communicate bi-directionally with other devices, such as the BSs 105 or network units. The modem subsystem 712 may be configured to modulate and encode the data from the memory 704 or the Quantization Parameter Signaling Module 708 according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., communication signals, data signals, control signals, physical layer messages, physical layer control information transport blocks, MAC PDUs, MAC SDUs, MAC-CEs, etc.) from the modem subsystem 712 (on outbound transmissions). The RF unit 714 may be further configured to perform analog beamforming in conjunction with the digital beamforming. Although shown as integrated together in transceiver 710, the modem subsystem 712 and the RF unit 714 may be separate devices that are coupled together at the UE 700 to enable the UE 700 to communicate with other devices.

The RF unit 714 may provide the modulated and processed data, e.g., data packets (or, more generally, data messages that may contain one or more data packets and other information), to the antennas 716 for transmission to one or more other devices. The antennas 716 may further receive data messages transmitted from other devices. The antennas 716 may provide the received data messages for processing and demodulation at the transceiver 710. The transceiver 710 may provide the demodulated and decoded data (e.g., communication signals, data signals, control signals, communication signals, data signals, control signals, physical layer messages, physical layer control information transport blocks, MAC PDUs, MAC SDUs, MAC-CEs, etc.) to the Quantization Parameter Signaling Module 708 for processing. The antennas 716 may include multiple antennas of similar or different designs in order to sustain multiple transmission links.

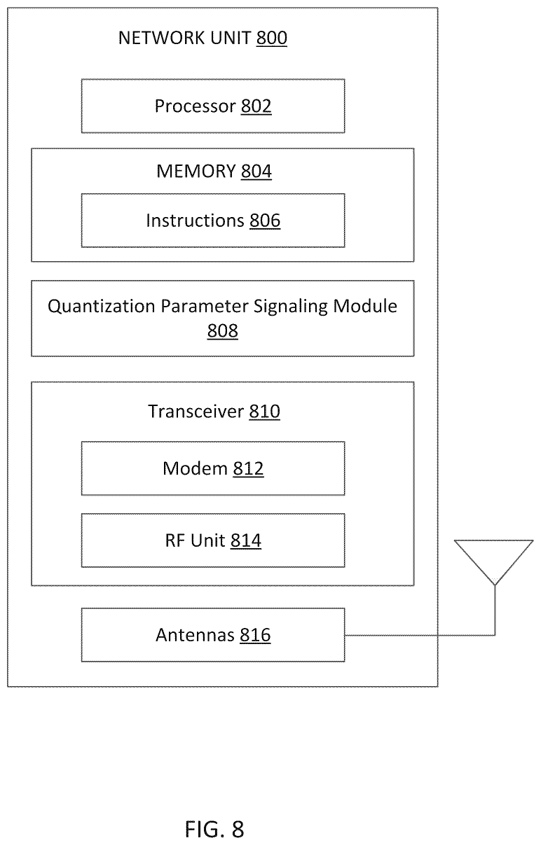

FIG. 8 is a block diagram of a network unit 800 according to one or more aspects of the present disclosure. The network unit 800 may be a BS 105, CU 210, DU 230, an RU 240, or a combination thereof, as discussed in FIGS. 1-2. The network unit 800 may include a BS. The BS may be an aggregated BS or a disaggregated BS, as described above. As shown, the network unit 800 may include a processor 802, a memory 804, a Quantization Parameter Signaling Module 808, a transceiver 810 including a modem subsystem 812 and a radio frequency (RF) unit 814, and one or more antennas 816. These elements may be coupled with one another. The term “coupled” may refer to directly or indirectly coupled or connected to one or more intervening elements. For instance, these elements may be in direct or indirect communication with each other, for instance via one or more buses.

The processor 802 may have various features as a specific-type processor. For instance, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, a solid state memory device, one or more hard disk drives, memristor-based arrays, other forms of volatile and non-volatile memory, or a combination of different types of memory. In some aspects, the memory 804 may include a non-transitory computer-readable medium. The memory 804 may store instructions 806. The instructions 806 may include instructions that, when executed by the processor 802, cause the network unit 800 to perform operations described herein, for instance, aspects of FIGS. 3-6. Instructions 806 may also be referred to as program code. The program code may be for causing a wireless communication device to perform these operations, for instance by causing one or more processors (such as processor 802) to control or command the network unit 800 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The Quantization Parameter Signaling Module 808 may be implemented via hardware, software, or combinations thereof. For instance, the Quantization Parameter Signaling Module 808 may be implemented as a processor, circuit, or instructions 806 stored in the memory 804 and executed by the processor 802. In some instances, the Quantization Parameter Signaling Module 808 can be integrated within the modem subsystem 812. For instance, the Quantization Parameter Signaling Module 808 can be implemented by a combination of software components (e.g., executed by a DSP or a general processor) and hardware components (e.g., logic gates and circuitry) within the modem subsystem 812. The Quantization Parameter Signaling Module 808 may communicate with one or more components of the network unit 800 to implement various aspects of the present disclosure, for instance, aspects of FIGS. 3-6.

In some aspects, the Quantization Parameter Signaling Module 808 may be configured, along with other components of the network unit 800, to communicate a downlink signal indicating one or more parameters or configurations for use by a UE in quantizing, demodulating, and decoding downlink signals. In some aspects, the Quantization parameters signaling module 808 is configured to indicate (e.g., via DCI, CSI-RS, etc.) one or more parameters for use by a UE to receive and decode downlink signals.

As shown, the transceiver 810 may include the modem subsystem 812 and the RF unit 814. The transceiver 810 can be configured to communicate bi-directionally with other devices, such as the UE 105, UE 600, or another network unit. The modem subsystem 812 may be configured to modulate and encode data according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data (e.g., communication signals, data signals, control signals, physical layer messages, physical layer control information transport blocks, MAC PDUs, MAC SDUs, MAC-CEs, etc.) from the modem subsystem 812 (on outbound transmissions). The RF unit 814 may be further configured to perform analog beamforming in conjunction with the digital beamforming. Although shown as integrated together in transceiver 810, the modem subsystem 812, or the RF unit 814 may be separate devices that are coupled together at the network unit 800 to enable the network unit 800 to communicate with other devices.

The RF unit 814 may provide the modulated and processed data, e.g., data packets (or, more generally, data messages that may contain one or more data packets and other information), to the antennas 816 for transmission to one or more other devices. The antennas 816 may further receive data messages transmitted from other devices and provide the received data messages for processing and demodulation at the transceiver 810. The transceiver 810 may provide the demodulated and decoded data (e.g., communication signals, data signals, control signals, physical layer messages, physical layer control information transport blocks, MAC PDUs, MAC SDUs, MAC-CEs, etc.) to the Quantization Parameter Signaling Module 808 for processing. The antennas 816 may include multiple antennas of similar or different designs in order to sustain multiple transmission links.

FIG. 9 is a block diagram of a Companion Device 900 according to one or more aspects of the present disclosure. The Companion Device 900 may be, for instance, a UE 115 as discussed in FIGS. 1 and 2. The companion device 900 may be the device 415a of FIG. 4, the device 513 of FIG. 5, or the device 613 of FIG. 6. In some aspects, the Companion Device 900 comprises a smart wearable device, such as a smart watch, smart glasses, a smart ring, or any other suitable wearable device. In some aspects, the Companion Device 900 may have power limitations or communication limitations compared to the UE 700, for instance. In some aspects, the Companion Device 900 may lack the capability to monitor one or more control channels (e.g., PDCCH). In other aspects, the Companion Device 900 may have the same limitations and capabilities as the UE 700. As shown, the Companion Device 900 may include a processor 902, a memory 904, a Quantization Parameter Signaling Module 908, a transceiver 910 including a modem subsystem 912 and an RF unit 914, and one or more antennas 916. These elements may be coupled with one another. The term “coupled” may refer to directly or indirectly coupled or connected to one or more intervening elements. For instance, these elements may be in direct or indirect communication with each other, for instance via one or more buses.

The processor 902 may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, solid state memory device, hard disk drives, other forms of volatile and non-volatile memory, or a combination of different types of memory. In an aspect, the memory 904 includes a non-transitory computer-readable medium. The memory 904 may store, or have recorded thereon, instructions 906. The instructions 906 may include instructions that, when executed by the processor 902, cause the processor 902 to perform the operations described herein with reference to a UE 115 in connection with aspects of the present disclosure, for instance, aspects of FIGS. 3-5C and 8. Instructions 906 may also be referred to as program code. The program code may be for causing a wireless communication device to perform these operations, for instance by causing one or more processors (such as processor 902) to control or command the Companion Device 900 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The Quantization Parameter Signaling Module 908 may be implemented via hardware, software, or combinations thereof. For instance, the Quantization Parameter Signaling Module 908 may be implemented as a processor, circuit, or as instructions 906 stored in the memory 904 and executed by the processor 902. In some aspects, the Quantization Parameter Signaling Module 908 can be integrated within the modem subsystem 912. For instance, the Quantization Parameter Signaling Module 908 can be implemented by a combination of software components (e.g., executed by a DSP or a general processor) and hardware components (e.g., logic gates and circuitry) within the modem subsystem 912. The Quantization Parameter Signaling Module 908 may communicate with one or more components of the Companion Device 900 to implement various aspects of the present disclosure, for instance, aspects of FIGS. 3-6.

In some aspects, the Quantization Parameter Signaling Module 908 may be configured, along with other components of the Companion Device 900, to receive one or more quantization parameters from a UE for use in quantizing one or more downlink communications. The one or more quantization parameters may include one or more of a quantization type, a sampling rate, or a decision threshold. In some aspects, the Quantization Parameter Signaling Module 908 may be configured to receive a communication indicating the one or more quantization parameters from the UE 700. In another aspect, the Quantization Parameter Signaling Module 908 is configured to participate in, or assist, the transmission of a quantized downlink signal to the UE 700, where the quantized signal is generated based on the one or more quantization parameters.

As shown, the transceiver 910 may include the modem subsystem 912 and the RF unit 914. The transceiver 910 can be configured to communicate bi-directionally with other devices, such as the BSs 105 or network units. The modem subsystem 912 may be configured to modulate and encode the data from the memory 904 or the Quantization Parameter Signaling Module 908 according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data (e.g., communication signals, data signals, control signals, physical layer messages, physical layer control information transport blocks, MAC PDUs, MAC SDUs, MAC-CEs, etc.) from the modem subsystem 912 (on outbound transmissions). The RF unit 914 may be further configured to perform analog beamforming in conjunction with the digital beamforming. Although shown as integrated together in transceiver 910, the modem subsystem 912 and the RF unit 914 may be separate devices that are coupled together at the Companion Device 900 to enable the Companion Device 900 to communicate with other devices.

The RF unit 914 may provide the modulated and processed data, e.g., data packets (or, more generally, data messages that may contain one or more data packets and other information), to the antennas 916 for transmission to one or more other devices. The antennas 916 may further receive data messages transmitted from other devices. The antennas 916 may provide the received data messages for processing and demodulation at the transceiver 910. The transceiver 910 may provide the demodulated and decoded data (e.g., communication signals, data signals, control signals, communication signals, data signals, control signals, physical layer messages, physical layer control information transport blocks, MAC PDUs, MAC SDUs, MAC-CEs, etc.) to the Quantization Parameter Signaling Module 908 for processing. The antennas 916 may include multiple antennas of similar or different designs in order to sustain multiple transmission links.

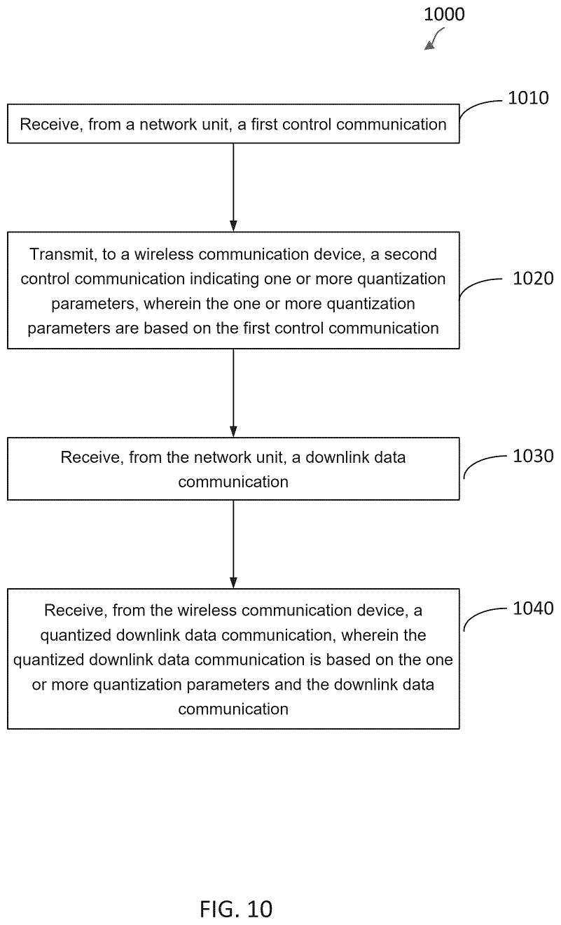

FIG. 10 is a flow diagram illustrating a wireless communication method 1000 according to one or more aspects of the present disclosure. Aspects of the method 1000 can be executed by a computing device (e.g., a processor, processing circuit, or other suitable component) of a first wireless communication device or other suitable means for performing the blocks. For instance, the first wireless communication device may be a UE (e.g., UE 115, UE 415b, UE 515, UE 615, or UE 700). The UE may utilize one or more components, such as the processor 702, the memory 704, the Quantization Parameter Signaling Module 708, the transceiver 710, the modem subsystem 712, the RF unit 714, the one or more antennas 716, or a combination thereof, to execute the blocks of method 1000. The method 1000 may employ similar mechanisms as described in FIGS. 3-6. As illustrated, the method 1000 includes a number of enumerated blocks, but aspects of the method 1000 may include additional blocks before, after, and in between the enumerated blocks. In some aspects, one or more of the enumerated blocks may be omitted or performed in a different order.

At block 1010, the UE receives, from a network unit, a first control communication. In one example, the first control communication comprises a DCI carried in a PDCCH. In another example, the first control communication comprises a reference signal. In one example, the first control communication comprises a CSI-RS. In some aspects, the UE receives the first control communication after performing an activation with a companion device to activate the companion device for monitoring one or more downlink channels. In another example, the UE receives the first control communication before performing the activation with the companion device.

At block 1020, the UE transmits, to a wireless communication device, a second control communication indicating one or more quantization parameters. The one or more quantization parameters may be based on the first control communication. For instance, the UE may determine, based on the first control communication, the one or more quantization parameters. The one or more quantization parameters may be associated with channel conditions or properties associated with the UE's Uu link with the network unit. In some aspects, the UE may determine the one or more quantization parameters based on a modulation and coding scheme (MCS), a rank, or both. The MCS and rank may be associated with the communication parameters used for communications between the UE and the network unit.

The one or more quantization parameters may include one or more of a quantization type, a number of bits per sample component, or a decision threshold. The one or more quantization parameters may be explicitly signaled by the UE (e.g., a value or index for each parameter), or implicitly signaled by the UE (e.g., an index associated with a quantization configuration). For instance, the wireless communication device (e.g., another UE, a wearable smart device, etc.) may be preconfigured with a finite number of quantization configurations, where each quantization configuration comprises one or more quantization parameter settings, and where each quantization configuration is associated with an index. The UE may indicate the quantization configuration for the companion device to use by transmitting an indication of an index. Thus, a single index may be used to indicate a configuration having a plurality of quantization parameters. In another example, the UE may indicate one index or value for each quantization parameter. Thus, the UE may transmit indications of multiple indices, values, or both, for the wireless communication device to use in quantization of downlink communications. In one aspect, the UE may transmit the second control communication over a UWB link, while the first control communication may be received over a Uu link from the network unit. In another example, the UE may transmit the second control communication to the wireless communication device using a sidelink (e.g., PC5), a Uu link, a WiFi, link, or any other suitable wireless link. The UE may transmit the second control communication periodically based on a configured set of periodic resources, or aperiodically. For instance, the UE may transmit the second control communication dynamically by scheduling the wireless communication device to receive the communication. In some aspects, the wireless communication device may be configured to monitor for the second control communication periodically or aperiodically.

In some aspects, the second control communication comprises an activation request for the wireless communication device. In other aspects, the UE may transmit the second control communication multiplexed with an activation request for the wireless communication device. In still other aspects, the UE may transmit the second control communication separately from the activation request.

At block 1030, the UE receives, from the network unit, a downlink data communication. In some aspects, the downlink data communication comprises a PDSCH communication carrying downlink data. In another aspects, the downlink data communication comprises both PDCCH and PDSCH. The PDSCH may carry one or more transport blocks (TBs). The one or more TBs may include one or more MAC PDUs, MAC-CEs, or any other suitable MAC layer element.

At block 1040, the wireless communication device receives, from the wireless communication device, a quantized downlink data communication. The quantized downlink data communication may be base don the one or more quantization parameters signaled by the UE at block 1020. The quantized downlink data communication may be further based on the downlink data communication, which is received both by the UE and by the wireless communication device. For instance, the downlink data communication may comprise a PDSCH carrying downlink data, which is received by both the UE and the wireless communication device. The UE and the wireless communication device may include separate antennae and signal processing circuitry such that the devices are relatively uncorrelated. The wireless communication device (e.g., another UE, a wearable smart device) receives the signal, filters, converts, and quantizes it based on the one or more quantization parameters. The wireless communication device then transmits, and the UE receives, the quantized downlink data communication. Accordingly, the UE itself receives and quantizes the downlink data communication, and receives another quantized version of the downlink data communication from the wireless communication device. The UE may receive the quantized downlink data communication over a UWB link. In other aspects, the UE may receive the quantized downlink data communication from the wireless communication device via a Uu link, a PC5 link, a WiFi link, or any other suitable type of wireless link.

In some aspects, the method 1000 further includes the UE demodulating and decoding the downlink data communication based on the downlink communication it receives, as well as the quantized downlink data communication received from the wireless communication device. In some aspects, the wireless communication may comprise a companion device that lacks Uu demodulation capabilities, Uu decoding capabilities, or both. In other aspects, the wireless communication device has those capabilities but does not use them, and transmits the quantized downlink data communication after the quantization stage.

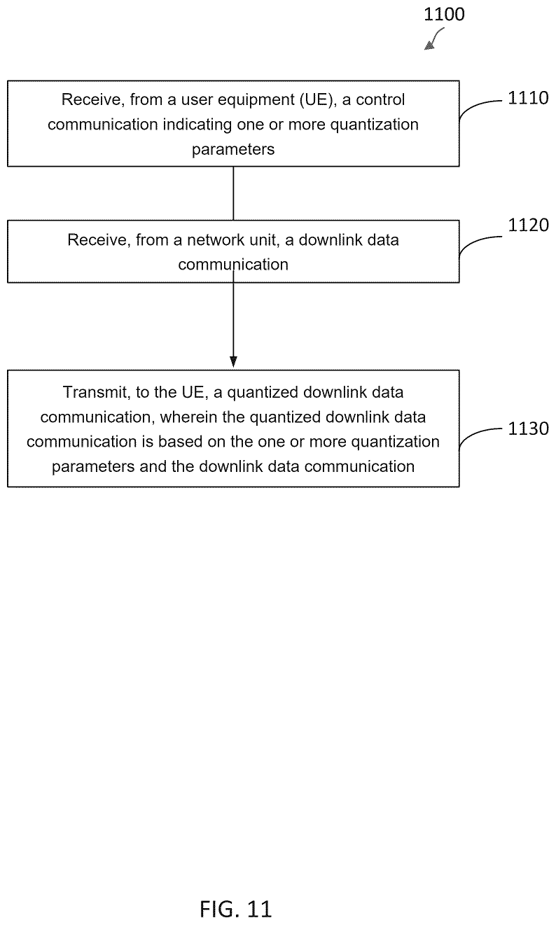

FIG. 11 is a flow diagram illustrating a wireless communication method 1100 according to one or more aspects of the present disclosure. Aspects of the method 1100 can be executed by a computing device (e.g., a processor, processing circuit, or other suitable component) of a wireless communication device or other suitable means for performing the blocks. For instance, the first wireless communication device may be a UE (e.g., UE 115 or UE 600), or a companion device (e.g., 513, 613, 900). The companion device may include, for instance, a smart wearable device that communicates with a UE over one or more wireless links. The one or more wireless links may include UWB, sidelink (PC5), WiFi, or a combination thereof. The wireless communication device may utilize one or more components, such as the processor 902, the memory 904, the Quantization Parameter Signaling Module 908, the transceiver 910, the modem subsystem 912, the RF unit 914, the one or more antennas 916, or a combination thereof, to execute the blocks of method 1100. The method 1100 may employ similar mechanisms as described in FIGS. 3-6. As illustrated, the method 1100 includes a number of enumerated blocks, but aspects of the method 1100 may include additional blocks before, after, and in between the enumerated blocks. In some aspects, one or more of the enumerated blocks may be omitted or performed in a different order.

At block 1110, the wireless communication device receives, from a UE, a control communication indicating one or more quantization parameters. The one or more quantization parameters may be based on the first control communication. For instance, the UE may determine, based on another communication (e.g., DCI, CSI-RS), the one or more quantization parameters. The one or more quantization parameters may be associated with channel conditions or properties associated with the UE's Uu link with the network unit. In some aspects, the UE may determine the one or more quantization parameters based on a modulation and coding scheme (MCS), a rank, or both. The MCS and rank may be associated with the communication parameters used for communications between the UE and the network unit.

The one or more quantization parameters may include one or more of a quantization type, a number of bits per sample component, or a decision threshold. The one or more quantization parameters may be explicitly signaled by the UE (e.g., a value or index for each parameter), or implicitly signaled by the UE (e.g., an index associated with a quantization configuration). For instance, the wireless communication device (e.g., another UE, a wearable smart device, etc.) may be preconfigured with a finite number of quantization configurations, where each quantization configuration comprises one or more quantization parameter settings, and where each quantization configuration is associated with an index. The UE may indicate the quantization configuration for the companion device to use by transmitting an indication of an index. Thus, a single index may be used to indicate a configuration having a plurality of quantization parameters. In another example, the UE may indicate one index or value for each quantization parameter. Thus, the wireless communication device may receive indications of multiple indices, values, or both, for the wireless communication device to use in quantization of downlink communications. In one aspect, the wireless communication device may receive the control communication over a UWB link, a sidelink (e.g., PC5), a Uu link, a WiFi, link, or any other suitable wireless link. The wireless communication device may receive the control communication periodically based on a configured set of periodic resources, or aperiodically.

In some aspects, the control communication comprises an activation request for the wireless communication device. In other aspects, the control communication may be multiplexed with an activation request for the wireless communication device. In still other aspects, the control communication may be received separately from the activation request.

At block 1120, the wireless communication receives, from a network unit, a downlink data communication. In some aspects, the downlink data communication comprises a PDSCH communication carrying downlink data. In another aspects, the downlink data communication comprises both PDCCH and PDSCH. The PDSCH may carry one or more transport blocks (TBs). The one or more TBs may include one or more MAC PDUs, MAC-CEs, or any other suitable MAC layer element.

At block 1130, the wireless communication device transmits, to the UE, a quantized downlink data communication. The quantized downlink data communication may be based on the one or more quantization parameters signaled by the UE at block 1110. The quantized downlink data communication may be further based on the downlink data communication, which is received both by the UE and by the wireless communication device. For instance, the downlink data communication may comprise a PDSCH carrying downlink data, which is received by both the UE and the wireless communication device. The UE and the wireless communication device may include separate antennae and signal processing circuitry such that the devices are relatively uncorrelated. The wireless communication device (e.g., another UE, a wearable smart device) receives the signal, filters, converts, and quantizes it based on the one or more quantization parameters. The wireless communication device then transmits, and the UE receives, the quantized downlink data communication. The wireless communication device may transmit the quantized downlink data communication over a UWB link. In other aspects, the wireless communication device may transmit the quantized downlink data communication to the UE via a Uu link, a PC5 link, a WiFi link, or any other suitable type of wireless link.

Other aspects of the present disclosure include:

Aspect 1. A method performed by a user equipment (UE), the method comprising: receiving, from a network unit, a first control communication; transmitting, to a wireless communication device, a second control communication indicating one or more quantization parameters, wherein the one or more quantization parameters are based on the first control communication; receiving, from the network unit, a downlink data communication; and receiving, from the wireless communication device, a quantized downlink data communication, wherein the quantized downlink data communication is based on the one or more quantization parameters and the downlink data communication.

Aspect 2. The method of aspect 1, wherein the one or more quantization parameters comprise one or more of: a quantization type; a number of bits per sample component; or a decision threshold.

Aspect 3. The method of aspect 1, wherein the second control communication explicitly indicates the one or more quantization parameters.

Aspect 4. The method of aspect 1, wherein the second control communication implicitly indicates the one or more quantization parameters via one or more index values.

Aspect 5. The method of aspect 1, wherein the transmitting the second control communication comprises transmitting the second control communication based on a periodic resource configuration.

Aspect 6. The method of aspect 1, wherein the receiving the first control communication comprises receiving a downlink control information (DCI).

Aspect 7. The method of aspect 6, wherein the method further comprises: transmitting, to the wireless communication device before the receiving the DCI, an activation request, wherein the activation request is associated with a sampling timing.

Aspect 8. The method of aspect 1, wherein the receiving the first control communication comprises receiving a channel state information resource signal (CSI-RS).

Aspect 9. The method of aspect 8, wherein the method further comprises: transmitting, to the wireless communication device after receiving the CSI-RS, an activation request, wherein the activation request is associated with a sampling timing.

Aspect 10. The method of aspect 8, wherein the second control communication includes an activation request associated with a sampling timing.

Aspect 11. The method of aspect 1, wherein the transmitting the second control communication comprises transmitting the second control communication by an ultra-wide band (UWB) link. 12. The method of aspect 1, wherein the receiving the quantized downlink data communication comprises receiving the quantized downlink data communication by an ultra-wide band (UWB) link.

Aspect 13. The method of aspect 1, further comprising: decoding, based on the downlink data communication and the quantized downlink data communication, the downlink data communication.

14. The method of aspect 1, wherein the wireless communication device comprises a wearable smart device.

Aspect 15. A method performed by a wireless communication device, the method comprising: receiving, from a user equipment (UE), a control communication indicating one or more quantization parameters; receiving, from a network unit, a downlink data communication; and transmitting, to the UE, a quantized downlink data communication, wherein the quantized downlink data communication is based on the one or more quantization parameters and the downlink data communication.

Aspect 16. The method of aspect 15, wherein the one or more quantization parameters comprise one or more of: a quantization type; a number of bits per sample component; or a decision threshold.

Aspect 17. The method of aspect 15, wherein the control communication explicitly indicates the one or more quantization parameters.

Aspect 18. The method of aspect 15, wherein the control communication implicitly indicates the one or more quantization parameters via one or more index values.

Aspect 19. The method of aspect 15, wherein the receiving the control communication comprises receiving the control communication based on a periodic resource configuration.

Aspect 20. The method of aspect 15, wherein the method further comprises: receiving, from the UE, an activation request, wherein the activation request is associated with a sampling timing.

Aspect 21. The method of aspect 15, wherein the receiving the control communication comprises receiving the control communication by an ultra-wide band (UWB) link.

Aspect 22. The method of aspect 15, wherein the transmitting the quantized downlink data communication comprises transmitting the quantized downlink data communication by an ultra-wide band (UWB) link.

Aspect 23. The method of aspect 15, further comprising: quantizing the downlink data communication based on the one or more quantization parameters to generate the quantized downlink data communication.

Aspect 24. The method of aspect 15, wherein the wireless communication device comprises a wearable smart device.

Aspect 25. The method of aspect 15, wherein the transmitting the quantized downlink data communication comprises transmitting the quantized downlink data communication by an ultra-wide band (UWB) link.

Aspect 26. A user equipment (UE), comprising: one or more memory devices; and one or more processors in communication with the one or more memory devices, wherein the UE is configured to perform the steps of any of aspects 1-14.

Aspect 27. A wireless communication device, comprising: one or more memory devices; and one or more processors in communication with the one or more memory devices, wherein the UE is configured to perform the steps of any of aspects 15-25.

Aspect 28. A non-transitory, computer-readable medium having program code recorded therein, wherein the program code comprises instructions executable by one or more processors of a UE to cause the UE to perform the steps of any of aspects 1-14.

Aspect 29. A non-transitory, computer-readable medium having program code recorded therein, wherein the program code comprises instructions executable by one or more processors of a wireless communication device to cause the wireless communication device to perform the steps of any of aspects 15-25.

Aspect 30. A user equipment (UE), comprising: means for performing the steps of any of aspects 1-14.

Aspect 31. A wireless communication device, comprising: means for performing the steps of any of aspects 15-25.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other aspects and implementations are within the scope of the disclosure and appended claims. For instance, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for instance, a list of items prefaced by a phrase such as “at least one of” or “one or more of”) indicates an inclusive list such that, for instance, a list of [at least one of A, B, or C] means A or B or C or AB or AC or BC or ABC (e.g., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some aspects thereof, but rather, should be fully commensurate with that of the claims appended hereafter and their functional equivalents.

What is claimed is:

1. A method performed by a user equipment (UE), the method comprising:
receiving, from a network unit, a first control communication;
transmitting, to a wireless communication device, a second control communication indicating one or more quantization parameters, wherein the one or more quantization parameters are based on the first control communication;
receiving, from the network unit, a downlink data communication; and
receiving, from the wireless communication device, a quantized downlink data communication, wherein the quantized downlink data communication is based on the one or more quantization parameters and the downlink data communication.

2. The method of claim 1, wherein the one or more quantization parameters comprise one or more of:
a quantization type;
a number of bits per sample component; or
a decision threshold.

3. The method of claim 1, wherein the second control communication explicitly indicates the one or more quantization parameters.

4. The method of claim 1, wherein the second control communication implicitly indicates the one or more quantization parameters via one or more index values.

5. The method of claim 1, wherein the transmitting the second control communication comprises transmitting the second control communication based on a periodic resource configuration.

6. The method of claim 1, wherein the receiving the first control communication comprises receiving a downlink control information (DCI).

7. The method of claim 6, wherein the method further comprises:
transmitting, to the wireless communication device before the receiving the DCI, an activation request, wherein the activation request is associated with a sampling timing.

8. The method of claim 1, wherein the receiving the first control communication comprises receiving a channel state information resource signal (CSI-RS).

9. The method of claim 8, wherein the method further comprises:
transmitting, to the wireless communication device after receiving the CSI-RS, an activation request, wherein the activation request is associated with a sampling timing.

10. The method of claim 8, wherein the second control communication includes an activation request associated with a sampling timing.

11. The method of claim 1, wherein the transmitting the second control communication comprises transmitting the second control communication by an ultra-wide band (UWB) link.

12. The method of claim 1, wherein the receiving the quantized downlink data communication comprises receiving the quantized downlink data communication by an ultra-wide band (UWB) link.

13. The method of claim 1, further comprising:
decoding, based on the downlink data communication and the quantized downlink data communication, the downlink data communication.

14. The method of claim 1, wherein the wireless communication device comprises a wearable smart device.

15. A method performed by a wireless communication device, the method comprising:
receiving, from a user equipment (UE), a control communication indicating one or more quantization parameters;
receiving, from a network unit, a downlink data communication; and
transmitting, to the UE, a quantized downlink data communication, wherein the quantized downlink data communication is based on the one or more quantization parameters and the downlink data communication.

16. The method of claim 15, wherein the one or more quantization parameters comprise one or more of:
a quantization type;
a number of bits per sample component; or
a decision threshold.

17. The method of claim 15, wherein the control communication explicitly indicates the one or more quantization parameters.

18. The method of claim 15, wherein the control communication implicitly indicates the one or more quantization parameters via one or more index values.

19. The method of claim 15, wherein the receiving the control communication comprises receiving the control communication based on a periodic resource configuration.

20. The method of claim 15, wherein the method further comprises:
receiving, from the UE, an activation request, wherein the activation request is associated with a sampling timing.

21. The method of claim 15, wherein the receiving the control communication comprises receiving the control communication by an ultra-wide band (UWB) link.

22. The method of claim 15, wherein the transmitting the quantized downlink data communication comprises transmitting the quantized downlink data communication by an ultra-wide band (UWB) link.

23. The method of claim 15, further comprising:
quantizing the downlink data communication based on the one or more quantization parameters to generate the quantized downlink data communication.

24. The method of claim 15, wherein the wireless communication device comprises a wearable smart device.

25. The method of claim 15, wherein the transmitting the quantized downlink data communication comprises transmitting the quantized downlink data communication by an ultra-wide band (UWB) link.

26. A user equipment (UE), comprising:
one or more memory devices; and
one or more processors in communication with the one or more memory devices, wherein the UE is configured to:
receive, from a network unit, a first control communication;
transmit, to a wireless communication device, a second control communication indicating one or more quantization parameters, wherein the one or more quantization parameters are based on the first control communication;
receive, from the network unit, a downlink data communication; and
receive, from the wireless communication device, a quantized downlink data communication, wherein the quantized downlink data communication is based on the one or more quantization parameters and the downlink data communication.

27. The UE of claim 26, wherein the one or more quantization parameters comprise one or more of:
a quantization type;
a number of bits per sample component; or
a decision threshold.

28. The UE of claim 27, wherein the UE is further configured to:
decode, based on the downlink data communication and the quantized downlink data communication, the downlink data communication.

29. A wireless communication device, comprising:
one or more memory devices; and
one or more processors in communication with the one or more memory devices, wherein the wireless communication device is configured to:
receive, from a user equipment (UE), a control communication indicating one or more quantization parameters;
receive, from a network unit, a downlink data communication; and
transmit, to the UE, a quantized downlink data communication, wherein the quantized downlink data communication is based on the one or more quantization parameters and the downlink data communication.

30. The wireless communication device of claim 29, wherein the one or more quantization parameters comprise one or more of:
a quantization type;
a number of bits per sample component; or
a decision threshold.
